(19) United States
(12) Patent Application Publication
(10) Pub. No.: US 2009/0090748 A1
(43) Pub. Date: Apr. 9, 2009

(54) Self opening pour spout and rotating nozzle

(76) Inventor: Albert Andrew Harrison, Brooklyn, NY (US)

Correspondence Address: Albert A. Harrison, 526 Ralph Avenue, Brooklyn, NY, 11233, US

(21) Appl. No.: 11/906,525

(22) Filed: Oct. 3, 2007

(51) Int. Cl. B67D 3/00

(52) U.S. Cl. 222/528

(57) ABSTRACT

I, Albert Harrison has, invented a pour spout with rotating nozzle that is affixed to a gable top carton, as set forth in the enclosed substitute specification.

A pour spout construction particular adapted for longer shelf life barrier paperboard containers, such as container of the gable top type. Barrier containers often carry products and interior surfaces of the former are lined or covered with a barrier layer. According to this invention the barrier layer is adhered to a siphon tube or other flexible tube attached creating water and air tight seal. A dispensing opening is formed in the paperboard and the additional barrier layer extends across and covers this opening. An externally rotating, pivoting or turn down pour spout, attached to the container, carries an innermost rotating ball or wheel which normally closes the pour spout. This ball carries an innermost opening whose lower edge is adhered to that barrier layer portion that spans the dispensing opening. When the pour spout is turned up, the innermost opening carries a part of the barrier layer away from its normal, sealing position, thus rupturing the barrier and permitting dispensing of the container, content.

### CROSS REFERENCE TO RELATED APPLICATIONS

“NOT APPLICABLE”

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISC APPENDIX

“NOT APPLICABLE”

### BACKGROUND OF THE INVENTION

This invention relates to the packaging of liquid or powdered products, such as fruit juices, milk, sugar, salt, soap powders and similar type products especially for carton construction which gives both the required protective barrier sealing of the product while at the same time allowing easy opening of the container for releasing its content.

In the field of protective barrier packaging, it is important that the interior surfaces of the container are completely covered or laminated with barrier layer materials. This layer may be formed from metal foil for example, or alternatively defined by a laminate of several layers, with each layer being of a different composition, such as polyethylene, etc. Additionally, it is desired that when the first dispensing operation is to take place, thereby wanting to break or rupture the barrier layer, that such breaking takes place with little or no inconvenience to the consumer. Exemplary of the efforts of others to provide a pour spout construction which will result in the breaking of a dispensing opening seal upon an initial use of the package are shown in U.S. Pat. No. 4,399,924 issued to Nilsson and U.S. Pat. No. 4,483,864 issued to Nomura. Other examples of combination liquid pour spout and seals are illustrated in U.S. Pat. Nos. 4,469,249, and 4,600,127, both issued to Malpas et al. and U.S. Pat. No. 4,813,578 issued to Gordon.

While they are operative for the purpose described for each of these constructions, none of them utilizes a barrier layer which covers the entire interior surface of the container, with this barrier layer functioning also as a seal for the dispensing spout. Also no one of them shows similar or exact construction.

### BRIEF SUMMARY OF THE INVENTION

According to the practice of this invention, a container for liquids and powders such as a gable top type carton formed from paperboard, provided with barrier layers over all its interior surfaces, is provided with a die cut dispensing opening in the paperboard, with this dispensing opening being spanned or covered by both the interior barrier layer and by the conventional outer layer of low density polyethylene on the exterior surface of the carton or container. A pour spout and rotating nozzle construction is provided wherein the pour spout is mounted exterior of container adjacent to the dispensing opening. A rotating nozzle pour spout is provided with an inner most spherical or circular wheel can adhere to the barrier layer or an additional barrier layer. By virtue of this construction, pulling up on the nozzle on the pour spout breaks this barrier layer to thereby permit dispensing of the liquid through the dispensing opening. Thus, no sharp implements are required for piercing the barrier layer only a tamper proof seal covers the entrance to the pour spout. Also, this pour spout construction can adhere to any barrier layer with proper glue or adhesive. Further, no screw cap is required the pour spout is air and water tight when it is in its push down position.

### BRIEF DESCRIPTION OF THE SEVERAL VIEWS OF THE DRAWING

FIG. 1 is a perspective view of a typical gable top liquid container provided with the pour spout and rotating nozzle construction of this invention.

FIG. 2 is a view taken along section 23-23 of FIG. 1.

FIG. 3 is an enlarged view of the encircled portion of FIG. 2.

FIG. 4 is a view similar to FIG. 2 and shows the configuration of pour spout and rotating nozzle construction of this invention immediately after rupture of the barrier layer has taken place upon the initial and subsequent open of the container.

### DETAILED DESCRIPTION OF THE INVENTION

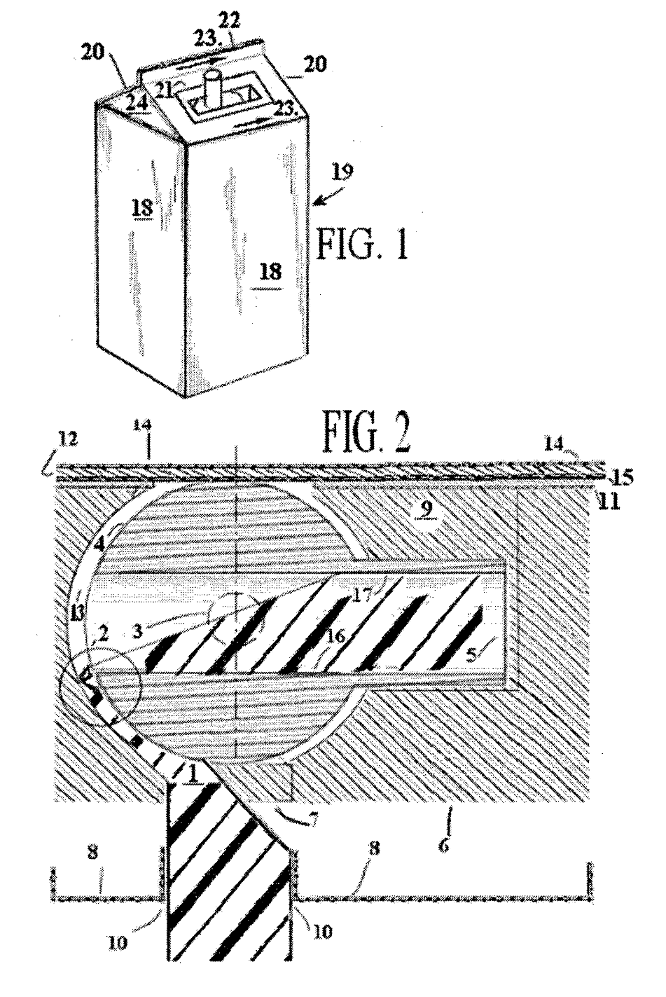

Referring now to FIG. 1, the numeral 19 denotes paper board container of conventional shape, provided with the pour spout and rotating nozzle construction of this invention. The container is generally square, having four sidewalls 18 and a gable top having a pair of opposed external walls 20 and a pair of internal gable top walls 24, only one of which is visible in FIG. 1 The bottom of carton 19 is closed so that it is flat. The numeral 22 denotes the usual sealing fin at the top of the gable, with numeral 21 denoting the pour spout and rotating nozzle construction of this invention, now to be described in detail.

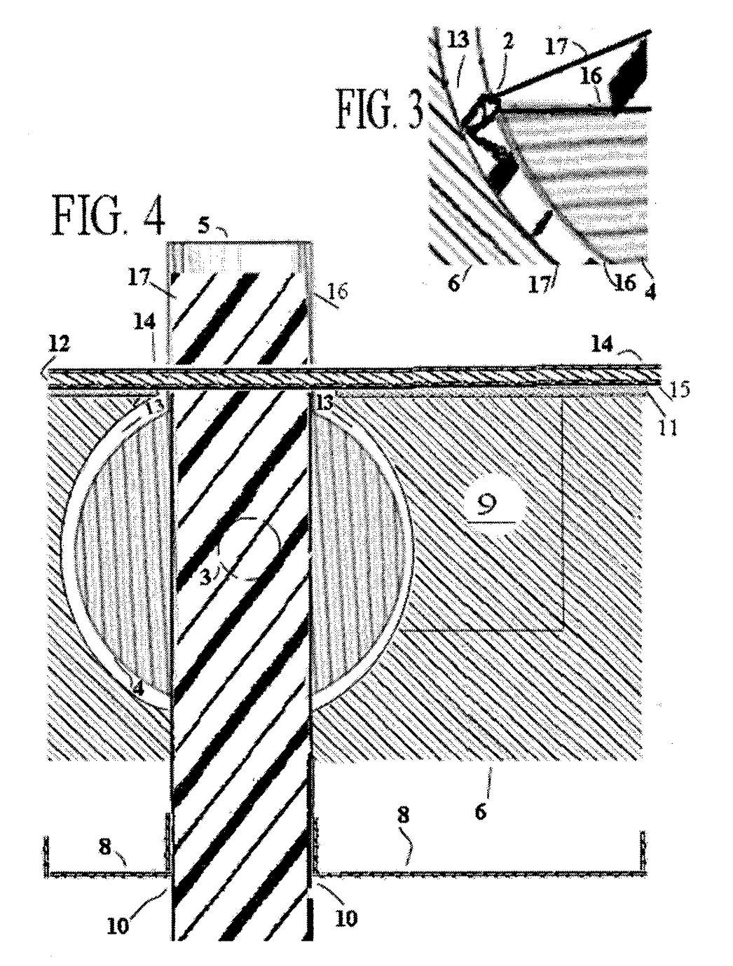

Referring now to FIGS. 2 and 4 of the drawings, the numeral 12 denotes the paperboard thickness from which the carton 19 is formed, the exterior surface of the paperboard being provided with a continuous extrusion of low density polyethylene, typically extrusion grade polyethylene of 0.75 of 1.0 mil in thickness. Such polyethylene layer on the external surface of the container is conventional in this art. The numerals 8 and 15 denote a carton interior barrier layers which may be defined by a single layer of, for example, Surlyn, a metallic foil, a layer of polyethylene, or other materials. Alternatively, the barrier layers 8 and 15 may be in the form of a laminate defined by two or more layers of different materials. The exact composition of laminate 8 and 15 forms no part of this invention, it being understood that its exact composition is determined by the product which is to be packaged in container 19. The numerals 10 and 11 denotes a die cut dispensing opening in paperboard 12 and barrier layer 8, this opening usually being die cut prior to the placement of layer 14 and 15 on opposite surfaces of the paperboard. The pour spout is defined by a cylindrical member 5 outwardly nozzle and having a lower spherical body 4 and holder 6. The holder 6 is adhered to a portion of the internal polyethylene coating 15 as shown in 11 in a manner that is not part of this invention. Glue or other adhesive maybe used.

The placement of the pour spout is such that its passageway is coincident with opening of the pour spout holder 7. The rotating nozzle defined by a spherical wheel 4 in channel 13 pivots on hinges 3 which are located on both sides of sphere 4. Only one hinge 3 position is shown on FIGS. 2 and 4. The mechanism or ways for the attachment of the two hinges 3 is not part of this invention and can be attached by various means such a screw or conical molding on either side of sphere 4 and attachment to holder 6 that allows the pour spout 5 to rotate clock wise. Only the out line of one of the hinge 3 is shown in FIGS. 2 and 4. The edges 16 and 17 of the flexible siphon tube 1, in FIG. 2 are adhered to the pour spout 5 by glue or other adhesives. The means or way of attaching the siphon tube to the pour spout upper most part is not part of this invention. Edges 16 and 17 are flexible, the action being such that upon rotating the nozzle counter clockwise in channel 13, the 17 edge will be force upwardly and away from the edge 16 at the lower most part 2 of pour spout 5 creating an opening in the siphon tube 1. The numeral 9 denotes a cut out in the holder 6 which acts as a lock for the pour spout nozzle creating a tight and snug fit to ensure that pressure is exerted against the siphon tube 1 at point 2 during the sealing process. The sealing process is similar to bending plastic drinking straw. At point 2 in FIG. 2 no liquid can pass when the siphon tube is bent creating a barrier layer. This provides a continuation of the sealing surface for barrier layers 8, 14 and 15.

Referring now to FIGS. 2 and 3 of the drawings, it will be seen that the bottom edge of dispensing opening 5 at point 2 in siphon tube 1 is blocked or covered completely by both siphon tube walls 17 and 16 creating a barrier layer in channel 13 and siphon tube 1. In channel 13, created by the walls of pour spout holder 6 and pour spout lower spherical body 4, the siphon tube 1 wall 17 is flat and bears upon and is adhered to siphon tube 1 wall 16. One manner of formation of the construction indicated in FIGS. 2 and 3 is as follows. After the formation of carton 19, but with the gable top still open and with the rotating nozzle and pour spout holder being hinged together, the assembly 21 is placed in the indicated position relative to opening 10, shown at FIGS. 1 and 4. A mandrel is inserted into the interior of the still open mouth of container 19, with the mandrel abutting the interior surface of barrier layer 15 and forming a backup support. Hot air or radiant heat is applied to the external surface of gable top wall 20 immediately around opening 10 to thereby soften the polyethylene coating 15, with holder 6 placed on the softened layer 15 to thereby adhere holder 6 to wall 20 and the base of holder 6 to layer 8. An external mandrel is also employed to press the assembly 21 against the internally positioned mandrel. This pressure is maintained until the coating 15 cools and thereby making a permanent adhesion of the holder 6 to layer 15 and the base of holder 6 to layer 8. It will be understood that this described manner of placing the assembly 21 on paperboard panel 20 is exemplary only, while other methods, such as ultrasonic adhesion, impulse heating, known to workers in this art may be employed. The particular process of the joining of the assembly 21 to panel portion 20 forms no part of the invention.

After the assembly 21 has been installed, the container 19 is filled with a particular liquid and the gable top is closed by convention apparatus or methods.

The operation of the invention described above is shown in FIG. 4 of the drawings. There, the rotating nozzle has been turned upwards by the user applying force to tip of the pour spout 5 uppermost tip, causing the pour spout spherical bottom 4 to move away from the interior of the pour spout holder 6, i.e., in a direction upwardly or counter clockwise turn, as indicated at FIGS. 2 and 4. This result in a rupture of the seal defined by the siphon tube 1 wall 17 and siphon tube wall 16, such that both of these layers are stretched and moved to thereby permit dispensing of the contents from the container 19 through opening 5 after the rotating nozzle has been completely rotated in a upright position, as seen in FIG. 1, with the pour spout pointing straight up.

From the above, it will be seen that the present invention yields a container and pour spout combination which utilizes the necessary interior barrier layer for the packaging of liquids and or powders, particularly in long shelf life barrier conditions, and which requires only a vertically extending (referring to FIG. 4) extension. Preferably, both the pour spout and the holder produced using conventional injection molding type machines. The material for the pour spout is polyethylene, a material which exhibits easy formability has been approved by the Food and Drug Administration. It also exhibits substantial heat seat compatibility with the low density polyethylene extrusion coating

Alternatively, the pour spout holder may be made of a higher density polyethylene if greater strength and formability is required. It will further be seen that rupture of exterior tamper proof coating, not shown as part of this invention, that cover the spout when it is in the pour spout holder effected not only by movement in a upward direction of pour spout 5 upon the initial rotating of the nozzle but the resealing of the container, in the event all of the contents have not been dispensed upon the initial opening, is effected by simply rotating the nozzle back down in a clockwise direction, although the barrier properties of the container will now have been lost due to rupture of the tamper proof seal covering the pour spout holder thus exposing barrier layers 8 or, 14 and 15 through which the siphon hose enters. In addition, as seen in FIG. 4, barrier layers 14 and 15 (having been ruptured) also lend visual proof of tampering.

It will further be observed that the adhering of the pour spout to the container does not require any additional or special adhesive materials in those cases wherein, as is conventional, the paperboard container is coated with an external layer of polyethylene. This polyethylene is serving its usual function, as well as functioning as an adhesive for attaching the pour spout. While the package 19 has been illustrated as of gable top form, the invention can be utilized with a package or container of any form.

I claim:

1. A pour spout and container construction adapted barrier packaging of liquids and or powders, including a closed container having an exterior and an interior surface, one portion of said container having an opening there through to thereby define a dispensing opening, a barrier layer on said interior surface completely spanning and covering said dispensing opening, a pour spout rigidly mounted on said container, said pour spout having a spout passageway at least partially aligned with said dispensing opening, a rotating spherical body mounted onto and carried by said pour spout by means of pour spout holder and said pour spout, said pour spout rotating nozzle normally closing said pour spout, said rotating nozzle including pour spout holder therewith, whereby when the rotating spherical body is pivoted with the pour spout by turning the rotating nozzle counter clockwise, the barrier layer is opened to thereby permit dispensing of any contents of the container through the dispensing opening.
